(19) United States
(12) Patent Application Publication
(10) Pub. No.: US 2009/0129218 A1
(43) Pub. Date: May 21, 2009

(54) OPTICAL DISK DEVICE

(76) Inventor: Nakayuki Kitaoka, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/916,421

(22) PCT Filed: Jun. 2, 2006
(86) PCT No.: PCT/JP2006/311135

§ 371 Date: Dec. 3, 2007

(30) Foreign Application Priority Data
Jun. 3, 2005 (JP) 2005-163934

(51) Int. Cl. G11B 7/00

(52) U.S. Cl. 369/44.32; G9B/7

(57) ABSTRACT

There is provided an optical disk device in which no deterioration in playability at resisting vibrations in a disk servo system is generated by inadvertently recognizing it is in a non-vibrating state irregardless of it is in a vibrating state in a disk servo system. By providing two threshold values of a threshold value for detecting a vibration state during a non-vibration state and a threshold value for detecting the non-vibration state during the vibration state, or by performing a filtering to an error signal using a filter having filter constants different between during the vibrating state and during the non-vibrating state, it is possible to prevent erroneous recognition of the non-vibration state and thereby to prevent deterioration in playability of the disk servo during resisting earthquake.

### TECHNICAL FIELD

The present invention relates to an optical disk device, and more particularly, to an optical disk device that can enhance the playability even at vibrations in an optical disk servo operation.

### BACKGROUND ART

In a disk device, such as CD or DVD, data which are spirally arranged on a rotating disk are read out by a laser light which is outputted from a pickup. As a control for realizing that, there are a focus control which focuses the laser light outputted from the pickup on the data on a track and a tracking control which positions the pickup on a predetermined track on a disk.

As a method for detecting focus errors in the above-described focus control, there is an a stigmatic method as a typical method. The mechanism of the astigmatic method is shown in FIG. 6. In the astigmatic method as shown on FIG. 6 (a), the laser light which is outputted from the laser diode and is reflected by the recording plane 61 of the disk to return to the optical system, passes through the collection lens 64 comprising a condensing lens 62 and a coupling lens 63, and a circular pillar lens 65, and is further inputted to the four piece divided detector (photo detector) 67. Then, an astigmatism is generated by the collection lens 64 and the circular pillar lens 65, and therefore, the signal inputted to the four piece divided detector 67 becomes a true circle when it is in-focus, while it becomes an ellipse when it is not in-focus. Accordingly, when the output which are positioned diagonally in the four-piece divided detector are respectively added and a difference between the added results is taken as shown in FIG. 6(b), an output of 0 is generated when it is in-focus, while an output corresponding to the amount of deviation is generated when it is deviated from in-focus. Further, while when the disk displacements are up to predetermined amounts in both of + direction and − direction, error signals which are approximately proportional to the original disk displacements are generated as shown in FIG. 6(c), while when the disk displacements exceed those, error signals which are approximately proportional to the original disk displacements are generated. This means that the servo processing can be taken place only within a certain disk displacement.

As a method for detecting tracking errors in the above-described tracking control, there is a three-spot method as a typical method. The mechanism of the three-spot method is described with FIG. 7. In FIG. 7, reference numeral 71 denotes a laser light, and numeral 72 denotes a light separation means for separating the laser light 71 into three light bundles. Reference numeral 73 denotes a pit on the disk, numeral 74 denotes a half mirror, numeral 76 denotes an amplifier, and numeral 77 denotes a difference signal, respectively. The characteristic of the three spot method resides in that in addition to a main spot 78a, two sub spots 78b and 78c for detecting tracking errors are provided. When the main spot 78a is in pursuit of the track correctly, the outputs of the two sub spots 78c and 78c which are equal to each other make the difference between the left and right detected light outputs zero, while when the main spot is deviated to either of left and right, either of the left or right light detected amount increases to increase the difference. Further, it is also apparent from FIG. 8 that the tracking errors have characteristics of sinusoidal waveforms with respect to displacements from the focus position (track position), and similarly as in cases of focus errors, and when the displacement from the focus position exceeds a certain amount, the original error signal which is in proportion to the disk displacement is not outputted. This also means that the servo processing can be taken place only within a certain disk displacement.

In cases where external vibrations are added to an optical disk player such as where music are reproduced in a portable player while walking, the pickup or the disk is fluctuated and the in-focus position of the pickup does not coincide with the disk surface, thereby there arise erroneous displacements in the signals which are outputted from the above-described signal generating circuit which are caused by the vibrations. Also, by observing these erroneous displacements, the CD player can detect vibrations having had occurred.

While if it is supposed that this state is maintained, the servo system tries to keep the pickup always in the in-focus position, since there may be cases where the complete tracking cannot be carried out and the disk record cannot be read out correctly even if the control of the pickup position is carried out, or cases where the vibrations are large and the pickup is made apart more than a certain distance, thereby errors cannot be read out correctly from the non-linear characteristics of the servo error signals as described, thereby disabling the servo processing itself. In order to avoid such phenomenon, in the conventional CD players, the servo filter gain is increased as a countermeasure to vibrations, as described in the following.

FIG. 9 shows an example of an optical disk servo system in a conventional optical disk device.

In FIG. 9, reference numeral 1 denotes a disk, numeral 2 denotes a spindle motor, numeral 3 denotes a pickup, numeral 4 denotes a head amplifier, numeral 5 denotes a pickup driver, numeral 7 denotes an error signal, numeral 8 denotes a servo filter gain at non-vibration, numeral 9 denotes a servo filter gain at vibrations, numeral 10 denotes a servo filter gain switch, numeral 11 denotes a vibration detection filter, numeral 13 denotes a vibration judging signal, and numeral 14 denotes a vibration detection threshold.

In an optical disk device, the pickup 3 irradiates a laser light to pits on the disk 1 to read out various signals, sends those signals to the head amplifier 4, and carries out processing of generating error signals, thereby generating error signals 6 of such as focus error and tracking error. The servo filter 7 generates signals for continuing the pursuit of the pickup 3 on the disk surface or the tracks on the basis of the error signals, and sends a signal that is obtained by performing a gain processing to the signal to the pickup driver 5. At usual non-vibration, the vibration detected signal 13 from the vibration judgment circuit 12 is in a state showing the non-vibration signal, and then, the servo-filter gain switch 10 is connected to the servo filer gain at non-vibration 8. The output from the servo filter 7 is converted into a signal which is in accordance with the standard of the pickup 3 in the driver 5, and the converted signal drives the pickup 3 to pursuit onto the disk with keeping in in-focus position.

Then, when the error signal 6 is disturbed due to occurrence of vibrations in this state, the vibration detection filter 11 extracts only the signal of vibration component frequency band, and send it to the vibration judgment circuit 12. The vibration judgment circuit 12 monitors the amplitude of the output from the vibration detection filter 11, and when it exceeds a predetermined threshold 14, it is judges as “vibrating state”, and the vibration detected signal 13 is set to “vibration detected state” during a time period of a predetermined time after the detection of the vibration. If a vibration is again detected during this time period, it is a gain set to the “vibration detected state” during a time period of the above-described predetermined time after that point of time. The servo filter gain switch 10 is switched to the side of the servo filter gain at vibration 9. Here, the servo filter gain at vibration 9 takes a value higher than the servo filer gain at non-vibration.

Here, a block diagram of an optical disk servo system, and a comparison between this diagram and a servo filter gain of a general gain characteristic is shown in FIG. 11.

From this FIG. 11, that which has a higher servo filter gain Gf has a lower gain characteristic in the low frequency range, and this means that if the servo filter gain is raised in this frequency range, the ability of the pickup 3 for tracking the disk 1 is improved, and there arise less influences by the vibrations in the servo operation. Similarly, not only by raising the gain of the servo gain but by changing the servo filter constant and raising the gain in the vibration frequency range, similar results are obtained, and the influences by the vibrations are reduced. In this way, in the vibration detected state, such a processing as described above that would suppress those vibrations is carried out, thereby preventing sound jumping and enhancing the playability.

When the vibrations diminish and the amplitude of the output from the vibration detected filter 11 is made smaller and it becomes lower than the vibration detected threshold after the servo filter gain at vibration is switched, the vibration judgment circuit 12 returns the vibration detected signal 13 to “non-vibration detected stare2, and based on this signal, the servo filter gain switch 10 switches to the side of the at non-vibration servo filter gain 8.

Patent document 1: Japanese published patent application Hei. 5-250706

In cases where the above-described method is employed, however, since the influences by vibrations which appear in the error signals are made small, as a result of that the vibrations are detected and the servo filter gain is raised thereby the effects by the vibrations are reduced, the detected vibration value is made lower than the vibration detection threshold 14, and the vibration judgment circuit 12 recognizes the non-vibration state, and thereby a phenomenon that the loop filter gain is returned to then on-vibration servo filter gain 8 occurs. In other words, in a state where the vibrations occur continuously, even when it is always in the vibrating state, the vibration judgment circuit 12 judges as “non-vibrating state”, and the servo filer gain is returned to the at non-vibrating servo filter gain 8, and thereby the playability is deteriorated.

The present invention is directed to solving the above-described problems and has an object to provide an optical disk device which can avoid incorrect recognition of being in non-vibrating state during the vibration state in an optical servo system thereby enabling preventing deterioration in playability during the vibration state.

### MEASURES TO SOLVE THE PROBLEMS

In order to solve the above-described problems, according to Claim 1 of the present invention, there is provided an optical disk device which includes a vibration judgment unit having two threshold values of a threshold value for detecting the vibration state during the non-vibration state and a threshold value for detecting the non-vibration state during the vibration state and performing a detection of the vibration state or the non-vibration state using respective threshold values for an error signal in an optical disk servo system or a signal that is obtained by extracting a signal of a certain frequency band from the error signal, wherein different gains or filter constants of a servo filter are set between when the non-vibration state is detected and when the vibration state is detected.

According to Claim 2 of the present invention, there is provided an optical disk device which includes a vibration detection filter which performs a processing to an error signal in an optical disk servo system, extracting a certain frequency band from the error signal during the non-vibration state, a non-vibration detection filter having a filter characteristic different from that of the vibration detection filter and performing a processing to the error signal, extracting a certain frequency band from the error signal during the vibration state, and a vibration judgment unit having a threshold value for an amplitude of the outputs of the vibration detection filter and the non-vibration detection filter and performing detection of the vibration state or the non-vibration state using the threshold value, wherein different gains or filter constants of a servo filter are set between when the non-vibration state is detected and when the vibration state is detected.

According to Claim 3 of the present invention, there is provided an optical disk device as defined in claim 2, wherein a gain of the non-vibration detection filter is larger than a gain of the vibration detection filter.

According to Claim 4 of the present invention, there is provided an optical disk device as defined in claim 2, wherein a pass frequency band of the vibration detection filter is higher than that of the non-vibration detection filter.

### EFFECTS OF THE INVENTION

According to an optical disk device of the present invention, since it is constructed such that, having a vibration detection threshold value for detecting the vibration state during the non-vibration state and a non-vibration detection threshold value for detecting the non-vibration state during the vibration state, a vibration detection and a non-vibration detection are respectively performed with different threshold values, it is possible to prevent from erroneously recognizing as being in the non-vibration state during being in the vibration state.

Further, according to an optical disk device of the present invention, since it is constructed so that, provided with a non-vibration detection filter and a vibration detection filter having different filter characteristics from each other, a filter used is switched between the two states of the vibration state and the non-vibration state, it is possible to prevent from erroneously recognizing as being in the non-vibration state during being in the vibration state.

### BRIEF DESCRIPTION OF THE DRAWINGS

FIG. 1 is a diagram illustrating a construction of an optical disk device according to a first embodiment of the present invention.

FIG. 2 is diagram for explaining an operation of the optical disk device according to the first embodiment of the present invention.

FIG. 3 is a diagram illustrating a construction of an optical disk device according to a second embodiment of the present invention.

FIG. 4 is a diagram for explaining an operation of an example for a vibration detection filter used in the optical disk device according to the second embodiment of the present invention.

FIG. 5 is a diagram for explaining an operation of another example for the vibration detection filter used in the optical disk device according to the second embodiment of the present invention.

FIG. 6 is a diagram illustrating a general astigmatic method.

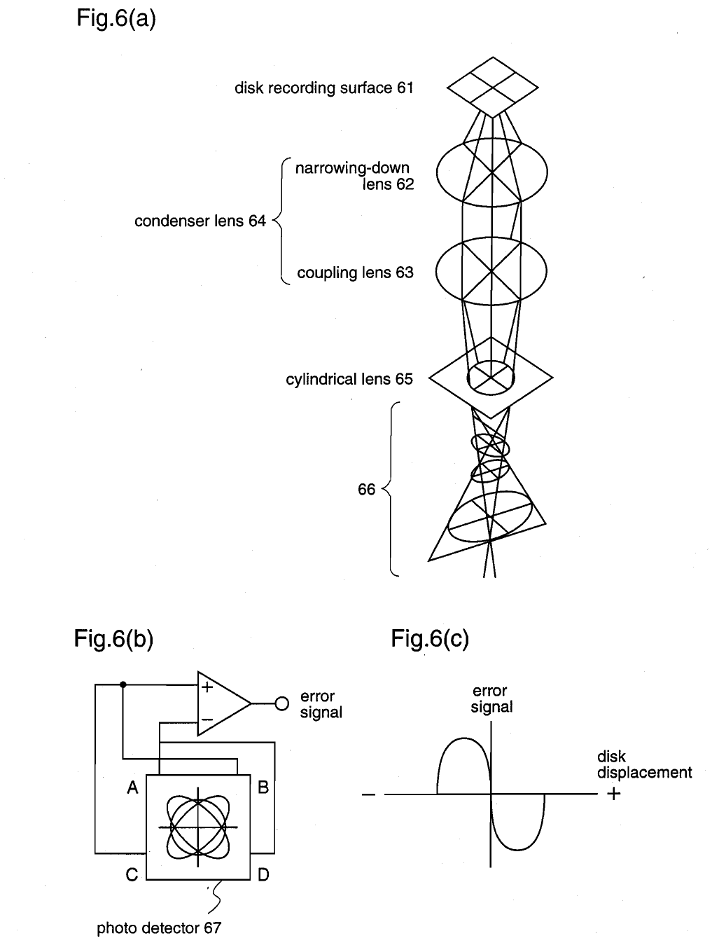

FIG. 7 is a diagram illustrating a general three spot method.

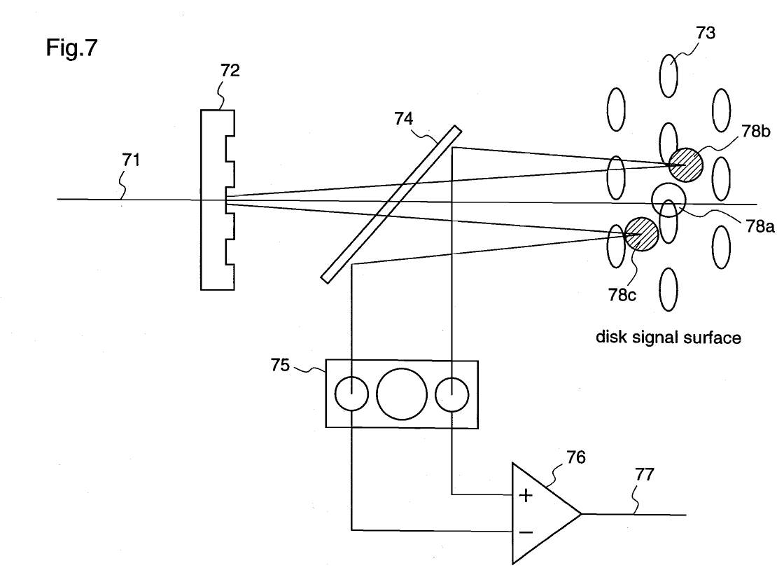

FIG. 8 is a diagram illustrating waveforms of tracking error signals in general.

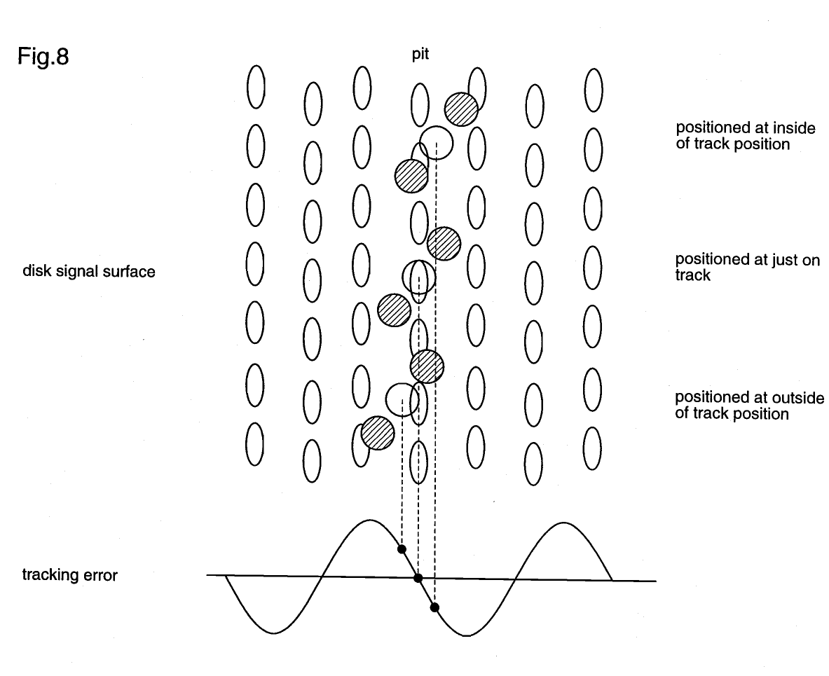

FIG. 9 is a diagram illustrating a conventional construction of an optical disk device which has implemented a countermeasure against earthquakes.

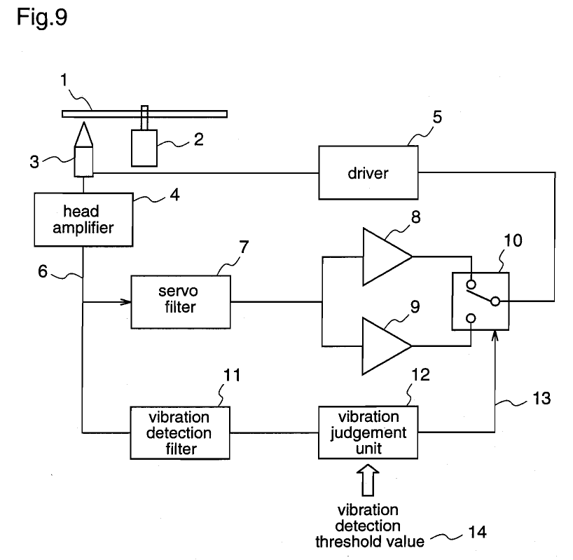

FIG. 10 is a diagram for explaining a conventional vibration detection method.

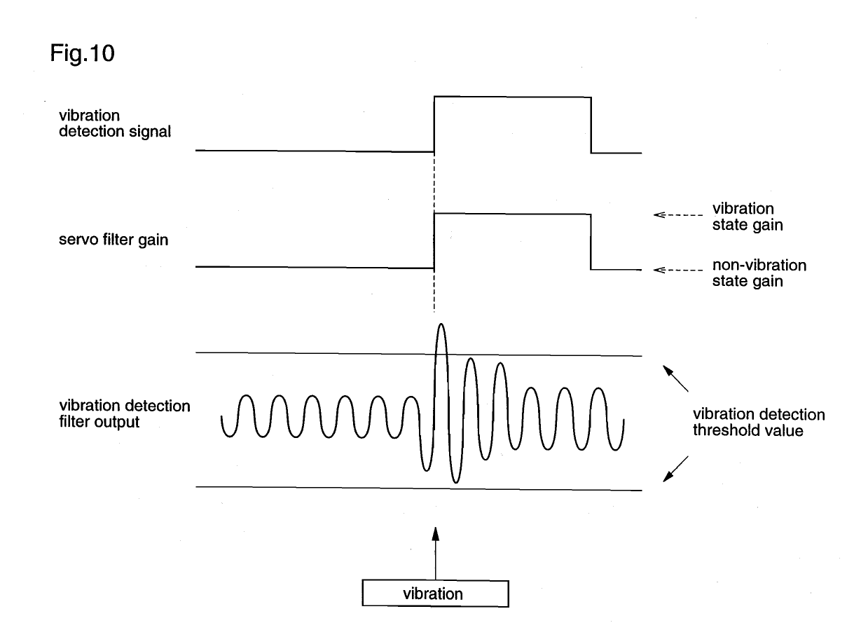

FIG. 11 is a schematic diagram illustrating a servo system in general.

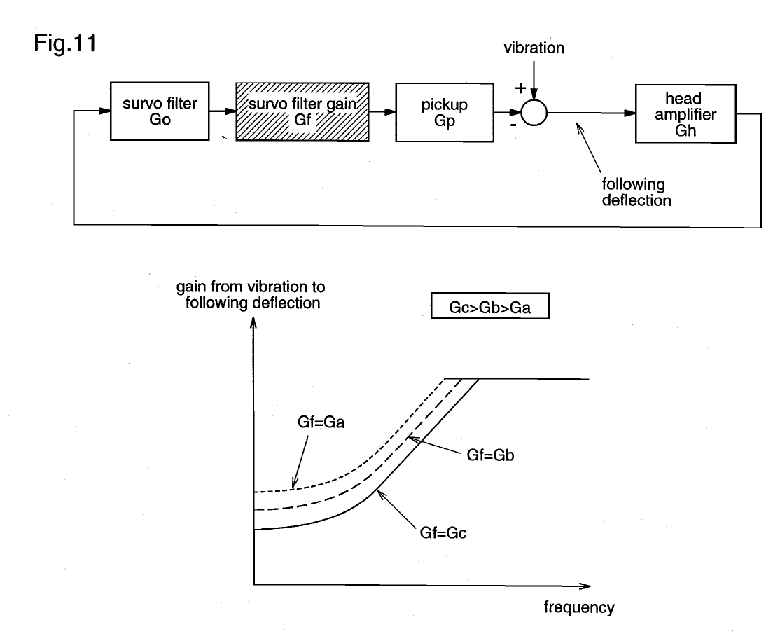

FIG. 12 is a diagram illustrating a manner that the non-vibrating state is erroneously judged in the conventional vibration detection method.

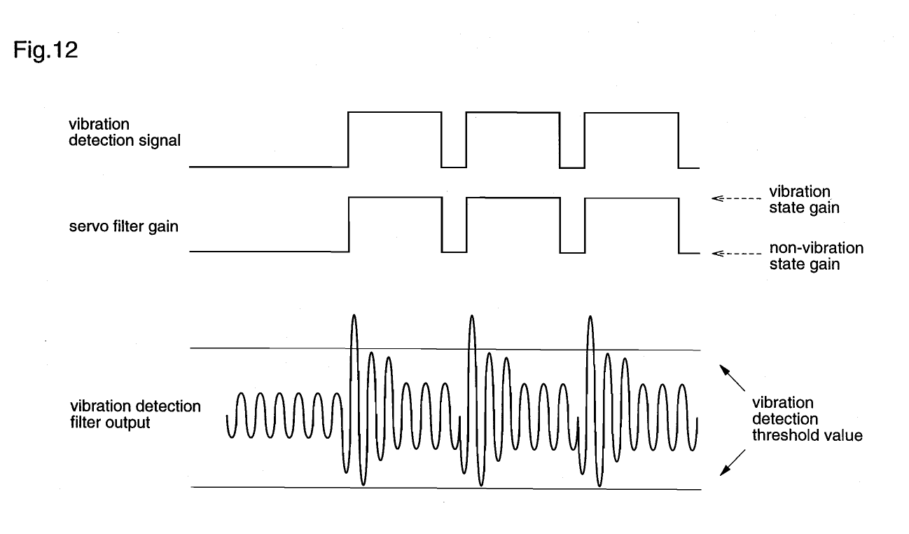

### DESCRIPTION OF REFERENCE NUMERALS

1 . . . disk
2 . . . spindle motor
3 . . . pickup
4 . . . head amplifier
5 . . . pickup driver
6 . . . error signal
7 . . . servo filter
8 . . . non-vibration state servo filter gain
9 . . . vibration state servo filter gain
10 . . . servo filter gain switching unit
11 . . . vibration detection filter
12 . . . vibration judgment unit
13 . . . vibration judged signal
14 . . . vibration detection threshold value
15 . . . non-vibration detection threshold value
16 . . . vibration judgment threshold value switching unit
17 . . . vibration detection filter
18 . . . non-vibration detection filter
19 . . . filter switching unit

### BEST MODE FOR CARRYING OUT THE INVENTION

Hereinafter, embodiments of the present invention will be described with reference to the drawings.

### First Embodiment

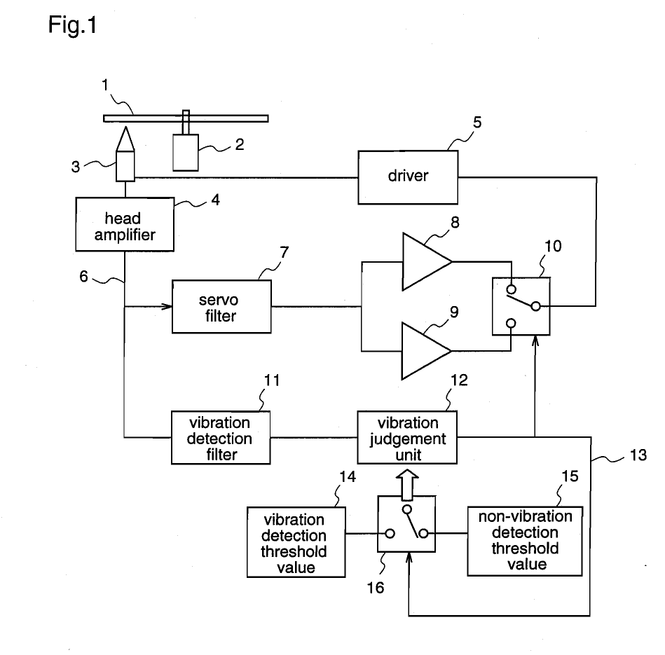

FIG. 1 illustrates an optical disk device according to a first embodiment of the present invention.

In FIG. 1, reference numeral 1 denotes a disk, numeral 2 denotes a spindle motor, numeral 3 denotes a pickup, numeral 4 denotes ahead amplifier, and numeral 5 denotes a pickup driver. Reference numeral 6 denotes error signals. Reference numeral 7 denotes a servo filter. Reference numeral 8 denotes a non-vibration state servo filter gain and numeral 9 denotes a vibration state servo filter gain. Reference numeral 10 denotes a servo filter gain switching unit, numeral 11 denotes a vibration detection filter, and numeral 12 denotes a vibration judgment unit. Reference numeral 13 denotes a vibration judged signal. Reference numeral 14 denotes a vibration detection threshold value, numeral 15 denotes a non-vibration detection threshold value, and reference numeral 16 denotes a vibration judgment threshold value switching unit.

An operation of the optical disk device of the first embodiment will be described.

In this optical disk device, the pickup 3 irradiates a laser light onto pits on the disk 1 during a servo operation, thereby to read out various kinds of signals. The read out signals are sent to the head amplifier 4 to be subjected to an error signal generating processing, whereby error signals 6 such as a focus error or a tracking error signal are generated. The servo filter 7 generates a signal for making the pick up 3 follow on a disk plane or on a track on the basis of the error signals 6.

When being in the non-vibration state, the vibration detection signal 13 outputted from the vibration judgment unit 12 is in a state showing “non-vibration state”, and then, the servo filter gain switching unit 10 is connected to the non-vibration state servo filter gain 8. So, a servo filter output signal is subjected to amplification by the non-vibrating state servo filter gain 8 and then sent to the driver 5, and is converted into a signal that is according to the standard of the pickup 3 in the driver 5, and this signal drives the pickup 3 to perform tracking onto the disk.

Though the judgment threshold value for the vibration detection in the vibration judgment unit 12 is always connected to the vibration detection threshold value 14 in the non-vibration state, when vibration occurs and the output from the vibration detection filter 11 exceeds this threshold value, the vibration judgment unit 12 changes the vibration detection signal 13 to “vibration state” and switches the servo filter gain switching unit 10 to the at vibration state servo filter gain 9 on the basis of that signal.

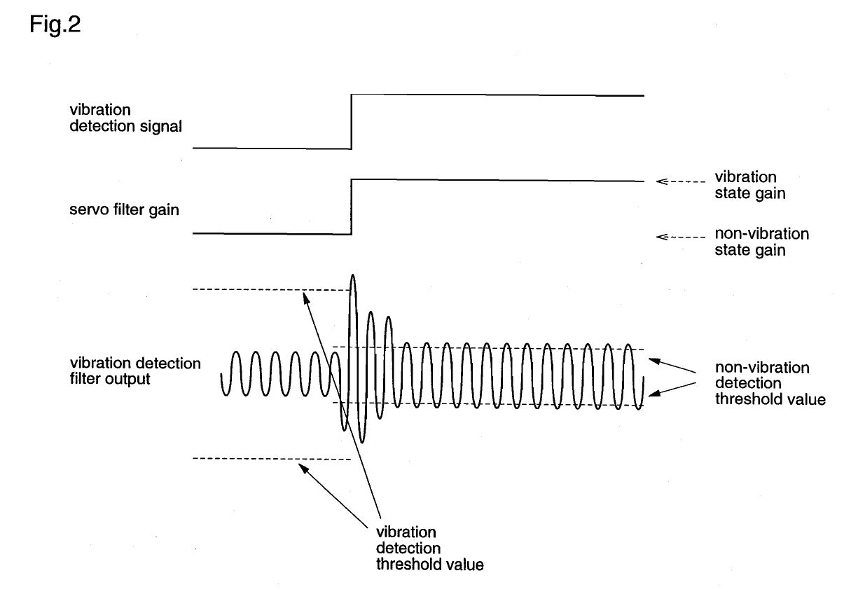

Concurrently with the above, the vibration judgment threshold value switching unit 16 is switched to the non-vibration detection threshold value 15, and henceforth, the vibration judgment unit 12 judges it being in the non-vibration detection state when the output from the vibration detection filter 11 has been lowered than this threshold value. By this operation, the optical disk device of this first embodiment can avoid that it is erroneously judged as it is being in non-vibration state by that the threshold value is switched to the non-vibration detection threshold 15 when it has become being in “vibration state” as show in FIG. 2.

As described, in the optical disk device according to this first embodiment of the present invention, there are provided the vibration detection threshold during the non-vibration detected state and the non-vibration detection threshold during the vibration detection state separately, and the non-vibration detection threshold is made lower than the vibration detection threshold. Thereby, such a phenomenon that the non-vibrating state is erroneously detected immediately after the gain is increased and then it is returned to the non-vibrating servo filter gain can be avoided, resulting in an enhancement in the playability during the vibration state.

### Second Embodiment

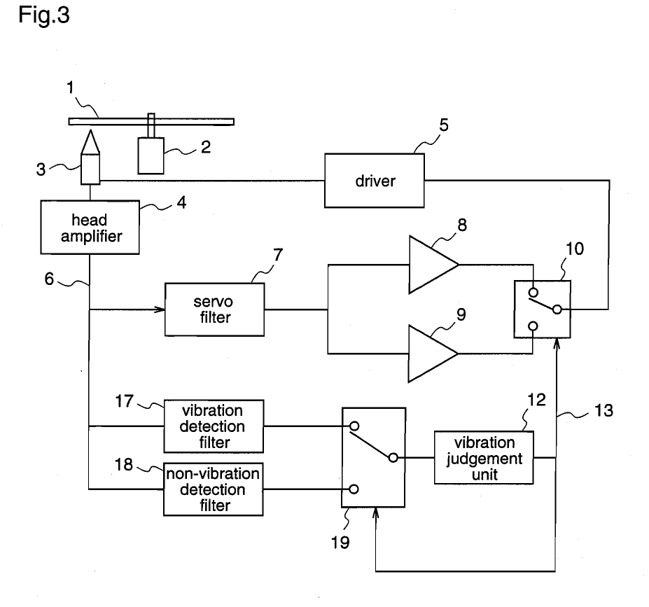

FIG. 3 is a diagram illustrating an optical disk device according to a second embodiment of the present invention.

In FIG. 3, reference numeral 1 denotes a disk, numeral 2 denotes a spindle motor, numeral 3 denotes a pickup, numeral 4 denotes ahead amplifier, and numeral 5 denotes a pickup driver. Reference numeral 6 denotes error signals. Reference numeral 7 denotes a servo filter. Reference numeral 8 denotes a non-vibration state servo filter gain and numeral 9 denotes a vibration state servo filter gain. Reference numeral 10 denotes a servo filter gain switching unit, numeral 11 denotes a vibration detection filter, and numeral 12 denotes a vibration judgment unit. Reference numeral 13 denotes a vibration detection signal. Reference numeral 17 denotes a vibration detection filter, numeral 18 denotes a non-vibration detection filter, and numeral 19 denotes a filter switching unit.

An operation of this second embodiment will be described.

In this optical disk device, the pickup 3 irradiates a laser light onto pits on the disk 1 during a servo operation, thereby to read out various kinds of signals. The read out signals are sent to the head amplifier 4 to be subjected to an error signal generating processing, whereby error signals 6 such as a focus error or a tracking error are generated. The servo filter 7 generates a signal for making the pick up 3 follow on a disk plane or on a track on the basis of this error signal 6.

When being in the non-vibration state, the vibration detection signal 13 outputted from the vibration judgment unit 12 is in a state showing “non-vibration state”, and then, the servo filter gain switching unit 10 is connected to the non-vibration state servo filter gain 8. So, a servo filter output signal is subjected to amplification by the non-vibrating state servo filter gain 8 and then sent to the driver 5, and is converted into a signal that is according to the standard of the pickup 3 in the driver 5, and this signal drives the pickup 3 to perform tracking onto the disk.

Though the filter switching unit 19 is always connected to the vibration detection filter 17 in the non-vibration state, when vibration occurs and the output from the vibration detection filter 17 exceeds a predetermined threshold value, the vibration judgment unit 12 changes the vibration detection signal 13 to “vibration detection state”, and switches the servo filter gain switching unit 10 to the at vibration servo filter gain 9 as well as switches the filter switching unit 19 to the non-vibration detection filter 18. Henceforth, the vibration judgment unit 12 judges it being in the non-vibration detection state when the output from the non-vibration detection filter 18 has been lowered than the threshold value.

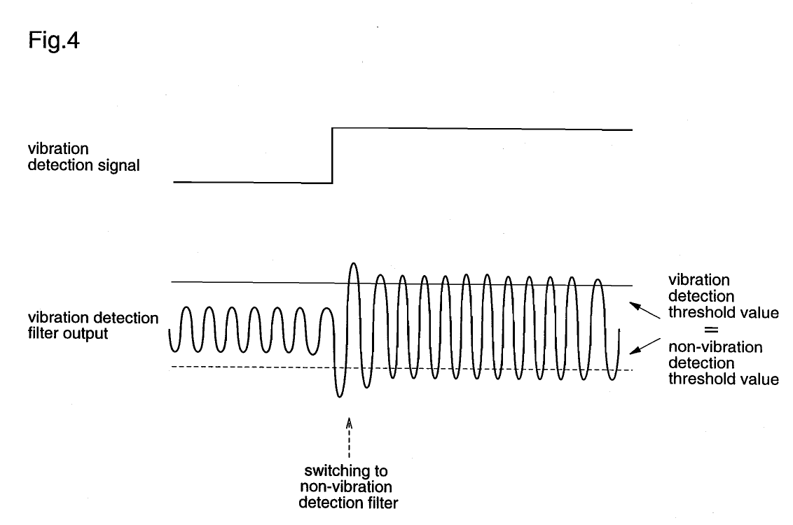

In this second embodiment, it can be employed a construction in which concerning the vibration detection filter 17 and the non-vibration detection filter 18, the output gain of the vibration detection filter 17 is larger than the output gain of the non-vibration detection filter 18, which makes the threshold values at the vibration detection and at the non-vibration detection equal to each other. This construction is equivalent to that two threshold values, i.e., a vibration detection threshold value and a non-vibration detection threshold value, are provided as in the first embodiment, and this can provide an effect of preventing that it is erroneously recognized as being in the non-vibration state during the vibration state as shown in FIG. 4.

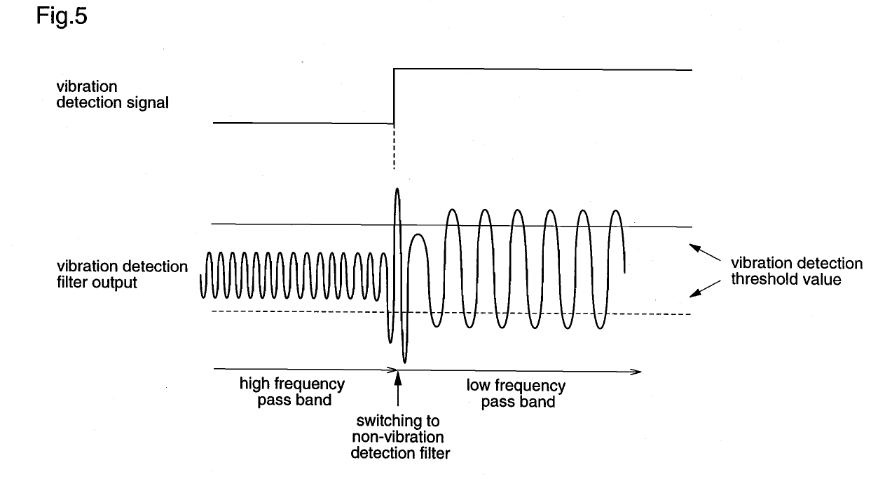

Alternatively in this second embodiment, it can be employed another construction in which the pass frequency band of the vibration detection filter 17 is larger than the pass frequency band of the non-vibration detection filter 18. In such construction, harmonic signals at the start of vibration can be easily captured based on the large pass frequency band of the vibration detection filter as shown in FIG. 5, thereby resulting in a fast detection of vibration. Further, employment of the non-vibration detection filter which cuts high frequency signals and passes only low frequency signals can provide secured detection of the stationary state.

As described, in the optical disk device according to this second embodiment, there are provided a vibration detection filter 17 performing a processing to an error signal 6 in an optical disk servo system, extracting a certain frequency band from the error signal 6 during the non-vibration state, a non-vibration detection filter 18 having a filter characteristic different from that of the vibration detection filter 17 and performing a processing to the error signal 6, extracting a certain frequency band from the error signal 6 during the vibration state, and a vibration judgment unit 12 having a threshold value for an amplitude of the outputs of the vibration detection filter and the non-vibration detection filter and performing detection of the vibration state or the non-vibration state using the threshold value, and different gains or filter constants of a servo filter are set between when then on-vibration state is detected and when the vibration state is detected. Thereby, the playability in the vibration state can be enhanced.

### APPLICABILITY IN INDUSTRY

The present invention has an effect of preventing deterioration in playability at vibration of a disc drive device, and it is very effective in enhancing the seismic function.

1. An optical disk device comprising:
a vibration judgment unit having two threshold values of a threshold value for detecting the vibration state during the non-vibration state and a threshold value for detecting the non-vibration state during the vibration state and performing a detection of the vibration state or the non-vibration state using respective threshold values for an error signal in an optical disk servo system or a signal that is obtained by extracting a signal of a certain frequency band from the error signal,
wherein different gains or filter constants of a servo filter are set between when the non-vibration state is detected and when the vibration state is detected.

2. An optical disk device comprising:
a vibration detection filter which performs a processing to an error signal in an optical disk servo system, extracting a certain frequency band from the error signal during the non-vibration state;
a non-vibration detection filter having a filter characteristic different from that of the vibration detection filter, which performs a processing to the error signal, extracting a certain frequency band from the error signal during the vibration state; and
a vibration judgment unit having a threshold value for an amplitude of the outputs of the vibration detection filter and the non-vibration detection filter and performing detection of the vibration state or the non-vibration state using the threshold value,
wherein different gains or filter constants of a servo filter are set between when the non-vibration state is detected and when the vibration state is detected.

3. The optical disk device as defined in claim 2, wherein
a gain of the non-vibration detection filter is larger than a gain of the vibration detection filter.

4. The optical disk device as defined in claim 2, wherein
a pass frequency band of the vibration detection filter is higher than that of the non-vibration detection filter.
